(19) United States
(12) Patent Application Publication
(10) Pub. No.: US 2026/0008360 A1
(43) Pub. Date: Jan. 8, 2026

(54) VEHICLE DRIVE UNIT

(71) Applicant: TOYOTA JIDOSHA KABUSHIKI KAISHA, Toyota-shi (JP)

(72) Inventors: Hiroki KUNIFUDA, Chiryu-shi (JP); Shinichiro SUENAGA, Nagoya-shi (JP)

(73) Assignee: TOYOTA JIDOSHA KABUSHIKI KAISHA, Toyota-shi (JP)

(21) Appl. No.: 19/047,734

(22) Filed: Feb. 7, 2025

(30) Foreign Application Priority Data
Jul. 3, 2024 (JP) 2024-107790

(51) Int. Cl. B60L 50/51; B60K 6/26; B60L 50/60

(52) U.S. Cl. CPC B60L 50/51; B60K 6/26; B60L 50/60; B60L 2210/14; B60L 2210/40

(57) ABSTRACT

In a vehicle drive unit, a drive chamber, a first electrical chamber, and a second electrical chamber are integrally arranged in such a manner that the first electrical chamber and the second electrical chamber are each adjacent to the drive chamber. The vehicle drive unit includes a first opening provided in a first wall surface of the first electrical chamber, and a second opening provided in a second wall surface of the second electrical chamber that is in contact with the first wall surface. The second opening is connected to the first opening. The vehicle drive unit includes an electrical equipment power line that electrically connects first electrical equipment and second electrical equipment. The electrical equipment power line is passed through the first opening and the second opening and disposed in the first electrical chamber and the second electrical chamber.

### CROSS-REFERENCE TO RELATED APPLICATION

This application claims priority to Japanese Patent Application No. 2024-107790 filed on Jul. 3, 2024. The disclosure of the above-identified application, including the specification, drawings, and claims, is incorporated by reference herein in its entirety.

### BACKGROUND

### 1. Technical Field

The present disclosure relates to vehicle drive units in which a drive chamber, a first electrical chamber, and a second electrical chamber are integrally arranged.

### 2. Description of Related Art

A vehicle drive unit is well known that includes: an electric motor; a gear unit to which the electric motor is connected in such a manner that power is transmittable; first electrical equipment that is a part of electrical equipment; second electrical equipment that is another part of the electrical equipment; a drive chamber that houses a drive unit, the drive unit including the electric motor and the gear unit; a first electrical chamber that houses the first electrical equipment; and a second electrical chamber that houses the second electrical equipment. The drive chamber, the first electrical chamber, and the second electrical chamber are integrally arranged in such a manner that the first electrical chamber and the second electrical chamber are each adjacent to the drive chamber. An example of such a vehicle drive unit is a drive device for a battery electric vehicle described in WO2013/069774. WO2013/069774 discloses that a case containing an inverter is disposed on the outer periphery of the body of an electric motor and a case containing a converter is disposed axially from the electric motor.

### SUMMARY

When the electrical equipment is divided into the first electrical equipment and the second electrical equipment and the first electrical equipment and the second electrical equipment are separately disposed, the first electrical equipment and the second electrical equipment need to be electrically connected to each other. Since each of the first and second electrical chambers is adjacent to the drive chamber, one possible way is to electrically connect the first electrical equipment and the second electrical equipment via the drive chamber. When the drive unit is to be lubricated with oil, the drive chamber needs to be sealed so that the oil does not leak out. Therefore, in order to dispose a power line between each of the first and second electrical chambers and the drive chamber, it is necessary to dispose, between each of the first and second electrical chambers and the drive chamber, a terminal block having a function to seal the drive chamber by closing a hole through which the power line is passed. This may increase the number of components.

The present disclosure was made in view of the above circumstances, and an object of the present disclosure is to provide a vehicle drive unit that can reduce an increase in the number of components when electrical equipment is divided and separately disposed.

According to a first aspect of the present disclosure, a vehicle drive unit includes: (a) an electric motor; a gear unit to which the electric motor is connected in such a manner that power is transmittable; first electrical equipment that is a part of the electrical equipment; second electrical equipment that is another part of the electrical equipment; a drive chamber that houses a drive unit, the drive unit including the electric motor and the gear unit; a first electrical chamber that houses the first electrical equipment; and a second electrical chamber that houses the second electrical equipment, the drive chamber, the first electrical chamber, and the second electrical chamber being integrally arranged in such a manner that the first electrical chamber and the second electrical chamber are cach adjacent to the drive chamber. The vehicle drive unit includes:
(b) a first wall surface that is a part of a wall surface of the first electrical chamber;
(c) a second wall surface that is a part of a wall surface of the second electrical chamber, the second wall surface being in contact with the first wall surface;
(d) a first opening provided in the first wall surface;
(e) a second opening provided in the second wall surface at a position facing the first opening, the second opening being connected to the first opening; and
(f) an electrical equipment power line that electrically connects the first electrical equipment and the second electrical equipment, the electrical equipment power line being passed through the first opening and the second opening and disposed in the first electrical chamber and the second electrical chamber.

In the vehicle drive unit according to the first aspect of the present disclosure, the drive chamber, the first electrical chamber, and the second electrical chamber are integrally arranged in such a manner that the first electrical chamber and the second electrical chamber are each adjacent to the drive chamber. The vehicle drive unit includes the first opening provided in the first wall surface of the first electrical chamber, and the second opening provided in the second wall surface of the second electrical chamber that is in contact with the first wall surface. The second opening is connected to the first opening. The vehicle drive unit includes the electrical equipment power line that electrically connects the first electrical equipment and the second electrical equipment. The electrical equipment power line is passed through the first opening and the second opening and disposed in the first electrical chamber and the second electrical chamber. This configuration allows the first electrical equipment and the second electrical equipment to be electrically connected without via the drive chamber, and can therefore reduce the number of terminal blocks required for electrical connection via the drive chamber. Accordingly, it is possible to reduce an increase in the number of components when the electrical equipment is divided and separately disposed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a schematic configuration of a vehicle to which the present disclosure is applied;

FIG. 2 is a diagram illustrating an example of an electrical configuration related to control of a first electric motor, a second electric motor, etc.;

FIG. 3A is a diagram illustrating an example of a schematic configuration of a vehicle drive unit;

FIG. 3B is a diagram illustrating another example of a schematic configuration of a vehicle drive unit;

FIG. 4A is a diagram illustrating an example of a configuration in which a first electrical chamber and a second electrical chamber are provided as one air chamber;

FIG. 4B is a diagram illustrating another example of a configuration in which a first electrical chamber and a second electrical chamber are provided as one air chamber;

FIG. 5A is a diagram illustrating an example of a configuration in which a first electrical chamber and a second electrical chamber are provided as one air chamber;

FIG. 5B is a diagram illustrating another example of a configuration in which a first electrical chamber and a second electrical chamber are provided as one air chamber;

FIG. 6A is a diagram illustrating an example of electrical connection in a drive unit;

FIG. 6B is a diagram illustrating another example of electrical connection in the drive unit;

FIG. 7A is a diagram illustrating an example of a schematic configuration of a vehicle drive unit of a comparative example;

FIG. 7B is a diagram illustrating another example of the schematic configuration of the vehicle drive unit of the comparative example;

FIG. 7C is a diagram illustrating still another example of the schematic configuration of the vehicle drive unit of the comparative example; and

FIG. 7D is a diagram illustrating yet another example of the schematic configuration of the vehicle drive unit of the comparative example.

### DETAILED DESCRIPTION OF EMBODIMENTS

Hereinafter, examples of the present disclosure will be described in detail with reference to the drawings.

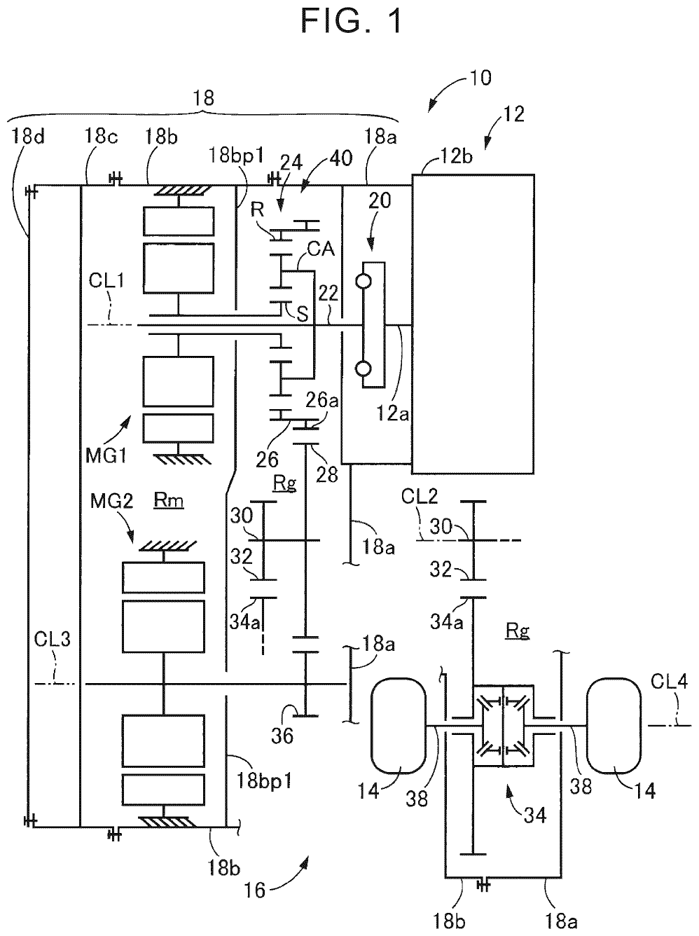

FIG. 1 is a diagram illustrating an example of a schematic configuration of a vehicle 10 to which the present disclosure is applied. In FIG. 1, the vehicle 10 is an electrified vehicle, in particular a hybrid electric vehicle, that includes an engine 12, a first electric motor MG1 and a second electric motor MG2. The vehicle 10 also includes drive wheels 14 and a power transmission device 16.

The engine 12 is a known internal combustion engine. The drive wheels 14 are left and right wheels relative to the forward travel direction of the vehicle 10. The power transmission device 16 is provided in a power transmission path between the engine 12 and the drive wheels 14 and in a power transmission path between the second electric motor MG2 and the drive wheels 14.

Each of the first electric motor MG1 and the second electric motor MG2 is a known rotary electric machine, and is a so-called motor generator. The first electric motor MG1 and the second electric motor MG2 are provided in a case 18 which is a non-rotating member attached to the vehicle body. Each of the first electric motor MG1 and the second electric motor MG2 is an electric motor connected to the power transmission device 16 so that power is transmittable.

The power transmission device 16 includes a damper 20, an input shaft 22, a differential mechanism 24, a compound gear 26, a driven gear 28, a driven shaft 30, a final gear 32, a differential gear 34, a reduction gear 36, and the like in the case 18. The power transmission device 16 includes a pair of drive shafts 38 etc. connected to the differential gear 34. Part of the drive shafts 38 is housed in the case 18.

The transmission unit 40 includes a first electric motor MG1 and the differential mechanism 24. The damper 20 is connected to the crankshaft 12a of the engine 12. The input shaft 22 is connected to the damper 20. The transmission unit 40 is connected to the input shaft 22. The compound gear 26 is a rotating body on the output side of the transmission unit 40. In the compound gear 26, a drive gear 26a is formed on a part of the outer peripheral surface. The driven gear 28 meshes with the drive gear 26a. The driven shaft 30 fixes the driven gear 28 and the final gear 32 so as not to be relatively rotatable. The final gear 32 is smaller in diameter than the driven gear 28 and meshes with a differential ring gear 34a of the differential gear 34. The reduction gear 36 is smaller in diameter than the driven gear 28 and meshes with the driven gear 28. A rotor shaft of the second electric motor MG2 is connected to the reduction gear 36, and the second electric motor MG2 is connected so that power is transmittable.

The differential mechanism 24 is a known single-pinion planetary gear set including a sun gear S, a carrier CA, and a ring gear R. A rotor shaft of the first electric motor MG1 is connected to the sun gear S, and the first electric motor MG1 is connected to the sun gear S so that power is transmittable. The carrier CA is connected to the input shaft 22. An engine 12 is connected to the carrier CA via an input shaft 22 etc. so that power is transmittable. The ring gear R is formed on a part of the inner peripheral surface of the compound gear 26 and is integrally connected to the drive gear 26a.

The differential mechanism 24 functions as a differential mechanism to which the engine 12 is connected so that power is transmittable and that generates a differential operation. The differential mechanism 24 is a power split mechanism that mechanically divides the power of the engine 12 input to the carrier CA into a first electric motor MG1 and a drive gear 26a. The transmission unit 40 is a known electric transmission mechanism in which the differential state of the differential mechanism 24 is controlled by controlling the operating state of the first electric motor MG1.

The power transmission device 16 is a gear unit to which an electric motor (first electric motor MG1, second electric motor MG2) is connected so that power is transmittable, except for the damper 20. The power output from the engine 12 is transmitted to the driven gear 28 via the transmission unit 40. The power output from the second electric motor MG2 is transmitted to the driven gear 28 via the reduction gear 36. The power transmitted to the driven gear 28 is sequentially transmitted to the drive wheels 14 via the driven shaft 30, the final gear 32, the differential gear 34, the drive shafts 38, etc.

In the power transmission device 16, a first axis CL1, a second axis CL2, a third axis CL3, and a fourth axis CL4 are parallel to each other. The first axis CL1 is an axis of the rotor shaft of the input shaft 22 or the first electric motor MG1, and is a rotation axis of the transmission unit 40 or the first electric motor MG1. The second axis CL2 is an axis of the driven shaft 30 and is a rotation axis of the driven gear 28 and the final gear 32. The third axis CL3 is an axis of the rotor shaft of the second electric motor MG2, and is a rotation axis of the reduction gear 36 and the second electric motor MG2. The fourth axis CL4 is an axis of the drive shafts 38 and is a rotation axis of the differential gear 34.

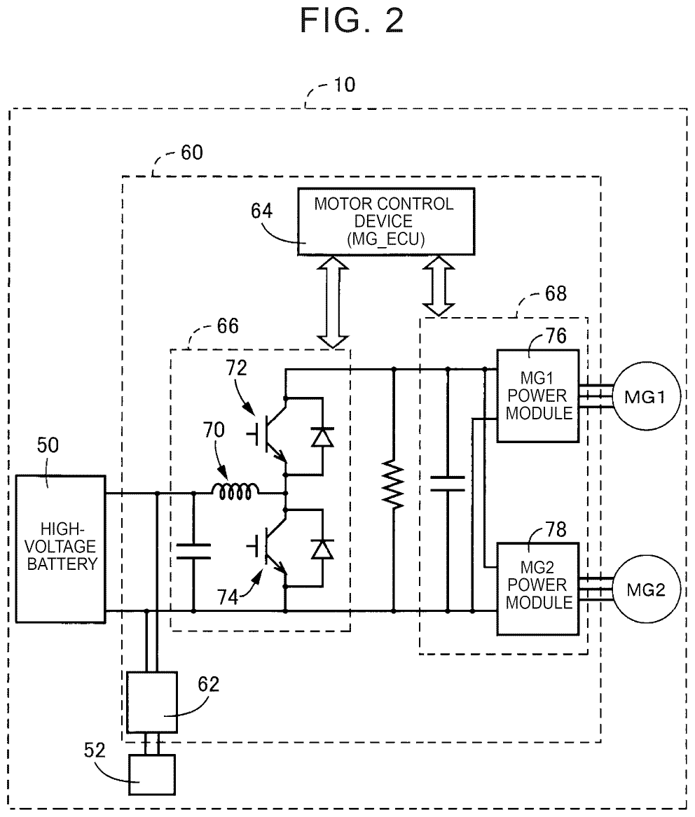

FIG. 2 is a diagram illustrating an exemplary electrical configuration related to control of the first electric motor MG1, the second electric motor MG2, etc. In FIG. 2, the vehicle 10 further includes a high-voltage battery 50, an auxiliary battery 52, a power control unit 60, and the like.

The high-voltage battery 50 is a chargeable/dischargeable DC power source, and is a secondary battery such as a nickel-hydrogen secondary battery or a lithium-ion battery. The high voltage battery 50 is connected to the power control unit 60. The stored electric power is supplied from the high-voltage battery 50 to, for example, the second electric motor MG2 via the power control unit 60. The high-voltage battery 50 is supplied with electric power by the power generation control of the first electric motor MG1 and electric power by the regenerative control of the second electric motor MG2 via the power control unit 60. The high-voltage battery 50 is a battery for driving.

The power control unit 60 is electrical equipment including a DCDC converter 62, a motor control device (MG_ECU) 64, a boost converter 66, an inverter 68, etc. The power control unit 60 is a power control device that controls electric power exchanged between the high-voltage battery 50 and the first electric motor MG1 and the second electric motor MG2.

DCDC converter 62 is connected to the high voltage battery 50. DCDC converter 62 functions as a charging device that reduces the voltage of the high-voltage battery 50 to a voltage equivalent to that of the auxiliary battery 52 and charges the auxiliary battery 52. The auxiliary battery 52 is a low-voltage battery that supplies electric power for operating an auxiliary machine provided in the vehicle 10, the motor control device 64, etc.

The boost converter 66 includes a reactor 70 and two switching elements 72, 74. The boost converter 66 is a buck-boost circuit having a function of boosting the voltage of the high-voltage battery 50 and supplying the boosted voltage to the inverter 68, and a function of stepping down the voltage converted into a direct current by the inverter 68 and supplying the stepped-down voltage to the high-voltage battery 50.

The inverter 68 includes a MG1 power module 76, a MG2 power module 78, and the like. MG1 power module 76 and MG2 power module 78 each include a switching clement and the like similar to the switching elements 72 and 74. The inverter 68 converts DC power from the high-voltage battery 50 boosted by the boost converter 66 into AC power and supplies the AC power to the first electric motor MG1 and the second electric motor MG2. The inverter 68 is a power supply unit that supplies electric power to the electric motor (first electric motor MG1, second electric motor MG2).

The motor control device 64 controls the boost converter 66 and the inverter 68 to control the first electric motor MG1 and the second electric motor MG2. For example, the motor control device 64 converts a direct current from the high-voltage battery 50 into an alternating current used for the first electric motor MG1 and the second electric motor MG2.

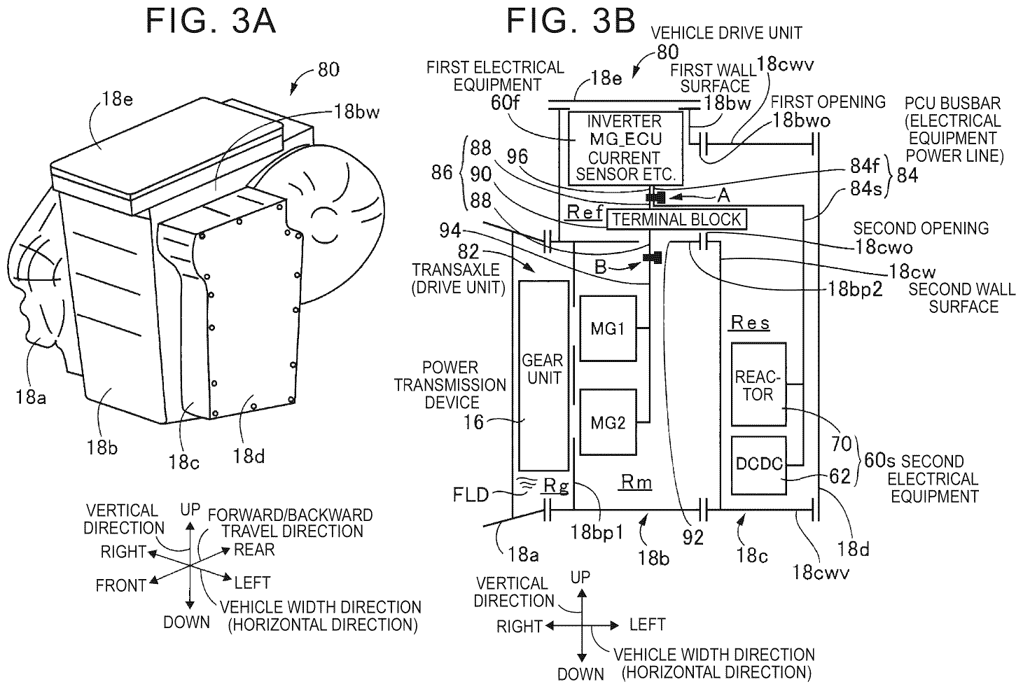

FIGS. 3A and 3B are diagrams illustrating an example of a schematic configuration of a vehicle drive unit 80 (hereinafter, referred to as drive unit 80). FIG. 3A is a perspective view showing an example of the appearance of the drive unit 80 as viewed from the front left side of a vehicle 10. FIG. 3B is a schematic diagram showing an example of the arrangement of components of the drive unit 80 as viewed from the front of the vehicle 10. In the drawings, the vertical direction, the forward/backward travel direction, and the vehicle width direction (horizontal direction) indicate directions in the state in which the drive unit 80 is mounted on the vehicle 10. The vehicle width direction is an axial direction such as the first axis CL1. Left and right in the vehicle width direction are left and right with respect to the forward travel direction of the vehicle 10.

In FIGS. 3A and 3B, the drive unit 80 includes a case 18. The case 18 includes a housing 18a, a case body 18b, a rear cover 18c, a side cover 18d, and an upper cover 18c.

In the housing 18a, an engine block 12b of the engine 12 is connected to an opened part of the engine 12 (see FIG. 1). The housing 18a and the case body 18b are integrally connected by fasteners such as bolts so that an opened portion of the housing 18a facing away from the engine 12 and an opening portion of the case body 18b located on the opposite side from the engine 12 are aligned with each other (see FIG. 1). The case body 18b and the rear cover 18c are integrally connected by fasteners so as to close an opening portion of the case body 18b located on the opposite side from the engine 12 with the rear cover 18c (see FIG. 1). The side cover 18d is connected to the rear cover 18c by fasteners so as to close the opening portion of the rear cover 18c located on the opposite side from the engine 12 (see FIG. 1). The upper cover 18e is connected to the case body 18b by a fastener so as to close an open part of a vertical upper portion of the case body 18b.

The case body 18b is a case including a first partition wall 18bp1 that separates the gear chamber Rg and the motor chamber Rm (see FIG. 1). The gear chamber Rg is a space that houses a gear unit (the power transmission device 16 excluding the damper 20). The motor chamber Rm is a space that houses an electric motor (first electric motor MG1, second electric motor MG2). The case body 18b forms a gear chamber Rg between the first partition wall 18bp1 and the housing 18a. The case body 18b forms a motor chamber Rm between the first partition wall 18bp1 and the rear cover 18c.

The drive unit 80 includes a power control unit 60 and a transaxle 82. The transaxle 82 is a drive unit including the power transmission device 16, the first electric motor MG1, and the second electric motor MG2. The gear chamber Rg and the motor chamber Rm constitute a drive chamber Rta that houses the transaxle 82. The drive chamber Rta has the function of an oil chamber sealed to prevent oil FLD that lubricates the transaxle 82 from leaking. The oil FLD is scraped up by, for example, the differential ring gear 34a or is supplied through an oil passage to lubricate the transaxle 82.

The power control unit 60 is divided into first electrical equipment 60f that is a part of the power control unit 60 and second electrical equipment 60s that is another part of the power control unit 60. The first electrical equipment 60f includes, for example, a motor control device 64 (see “MG_ECU” in FIGS. 3A and 3B), an inverter 68, a current sensor, etc. The current sensor is a sensor that detects the currents of the first electric motor MG1 and the second electric motor MG2 and supplies the detected signals to the motor control device 64. The second electrical equipment 60s includes, for example, a DCDC converter 62 and a reactor 70.

The case body 18b has a bottom wall and side walls extending vertically upward from the outer peripheral edge of the bottom wall on the front side and the rear side in the forward/backward travel direction, and is open on top in the vertical direction. The upper cover 18e is a plate-shaped member that closes an upper opening in the vertical direction of the case body 18b. The case body 18b is a case including a second partition wall 18bp2 that separates the drive chamber Rta that is a lower space in the vertical direction and the first electrical chamber Ref that is an upper space in the vertical portion. The case body 18b forms, between the second partition wall 18bp2 and the upper cover 18e, a first electrical chamber Ref that houses the first electrical equipment 60f. The first electrical chamber Ref is an air chamber.

The side cover 18d is a plate-shaped member that closes an opening of the rear cover 18c located on the opposite side from the engine 12. The rear cover 18c forms the second electrical chamber Res that houses the second electrical equipment 60s by closing the opening on the opposite side from the engine 12 with the side cover 18d. The second electrical chamber Res is an air chamber.

The drive unit 80 is a unit in which the transaxle 82 and the power control unit 60 are integrally arranged, that is, an integrated electromechanical unit. The drive unit 80 is an integrated electromechanical unit in which the drive chamber Rta, the first electrical chamber Ref, and the second electrical chamber Res are integrally arranged in such a manner that the first electrical chamber Ref and the second electrical chamber Res are each adjacent to the drive chamber Rta.

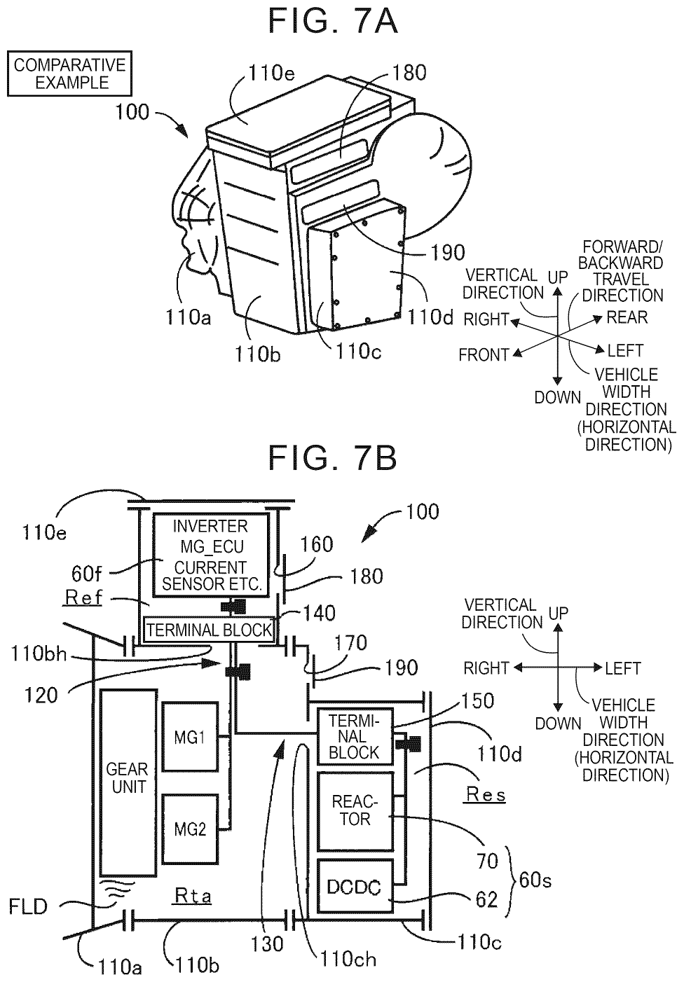

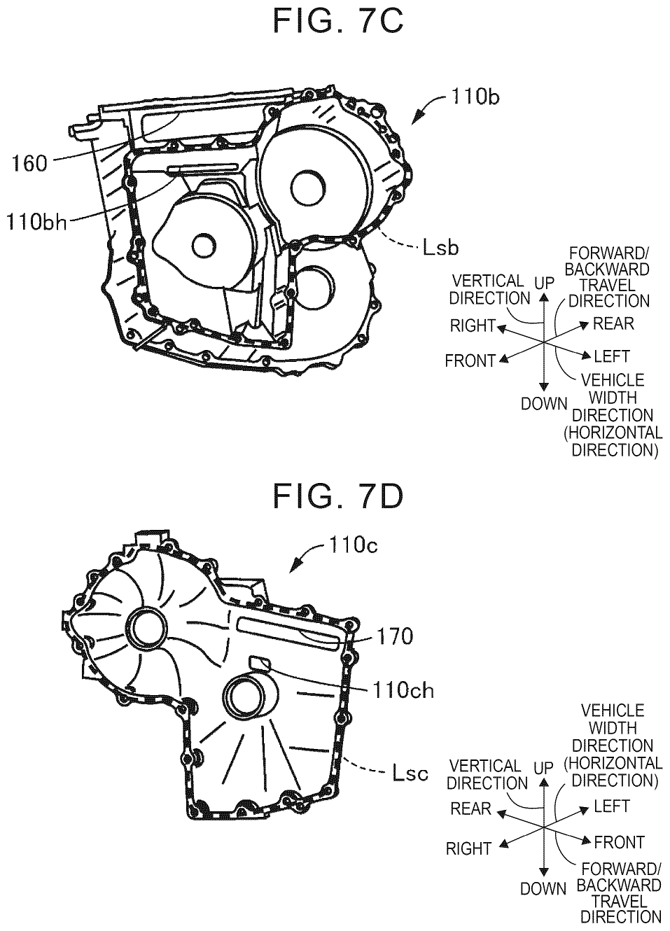

When the power control unit 60 is divided into the first electrical equipment 60f and the second electrical equipment 60s and the first electrical equipment 60f and the second electrical equipment 60s are separately disposed, the first electrical equipment 60f and the second electrical equipment 60s need to be electrically connected to each other. In the vehicle drive unit 100 of the comparative example shown in FIG. 7A, the first electrical equipment 60f and the second electrical equipment 60s are electrically connected via the drive chamber Rta. Like the case 18, the case 110 included in the vehicle drive unit 100 includes a housing 110a, a case body 110b, a rear cover 110c, a side cover 110d, and an upper cover 110e. The case body 110b is formed with a hole 110bh through which a busbar 120, namely a power line disposed between the first electrical chamber Ref and the drive chamber Rta, is passed. The rear cover 110c has a hole 110ch through which a busbar 130, namely a power line disposed between the first electrical chamber Ref and the second electrical chamber Res via the drive chamber Rta, is passed. The drive chamber Rta must be sealed to prevent leakage of oil FLD. Therefore, when the busbars 120, 130 are disposed, the terminal block 140 having a function of closing the hole 110bh and sealing the drive chamber Rta needs to be arranged. In addition, when the busbar 130 is disposed, the terminal block 150 having a function of closing the hole 110ch and sealing the drive chamber Rta needs to be arranged. In addition, in the vehicle drive unit 100, work service holes 160, 170 need to be formed in the case 18 so that the work of connecting the busbars 120, 130 to the terminal block 140 can be performed. Therefore, it is necessary to provide service hole covers 180, 190 for closing the service holes 160, 170, respectively. As a result, in the vehicle drive unit 100, since two terminal blocks 140, 150 and two service hole covers 180, 190 are provided, the number of components may increase. FIG. 7A is a perspective view showing an example of the appearance of the vehicle drive unit 100 as viewed from the front left side. FIG. 7B is a schematic diagram showing an example of the arrangement of components of the vehicle drive unit 100 as viewed from the front. FIG. 7C is a perspective view showing an example of the appearance of the case body 110b as viewed from the front left side. FIG. 7D is a perspective view showing an example of the appearance of a rear cover 110c as viewed from the front right side. The thick dashed line Lsb in FIG. 7C and the thick dashed line Lsc in FIG. 7D indicate a seal line for sealing the drive chamber Rta (oil chamber), and correspond to a mating surface between the case body 110b and the rear cover 110c.

In the drive unit 80, in order to reduce an increase in the number of components, the first electrical chamber Ref and the second electrical chamber Res are connected to form one air chamber, so that the first electrical equipment 60f and the second electrical equipment 60s are electrically connected without via the drive chamber Rta.

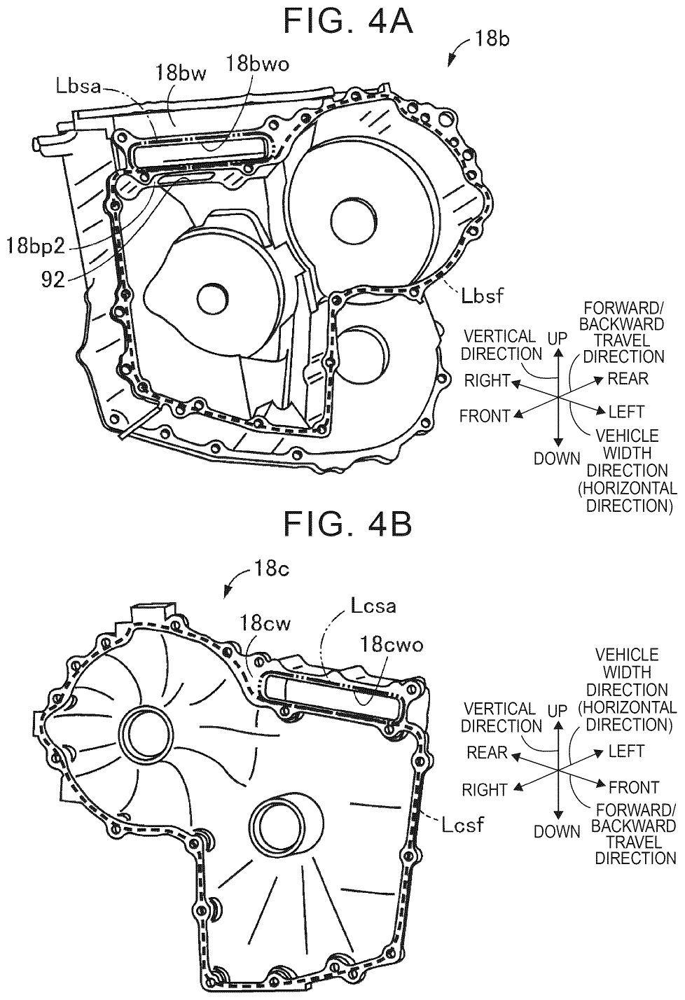

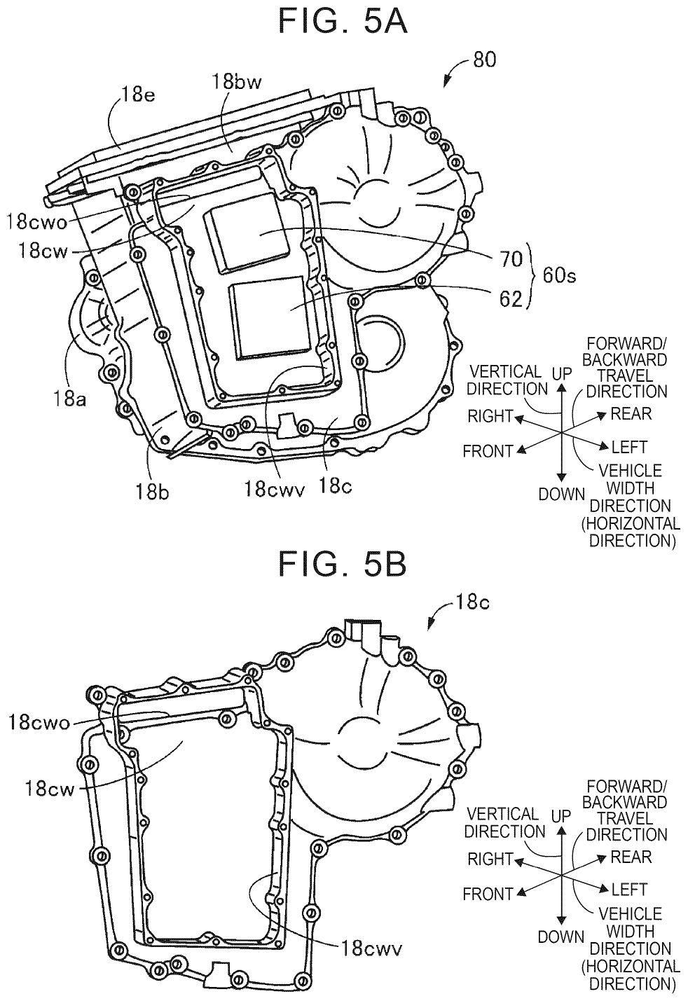

FIGS. 4A, 4B, 5A, and 5B are diagrams each illustrating an example of the configuration in which the first electrical chamber Ref and the second electrical chamber Res are provided as one air chamber. FIG. 4A is a perspective view showing an example of the appearance of the case body 18b as viewed from the front left side. FIG. 4B is a perspective view showing an example of the appearance of a rear cover 18c as viewed from the front right side. FIG. 5A is a perspective view showing an example of the appearance of the drive unit 80 without a side cover 18d attached as viewed from the front left side. FIG. 5B is a perspective view showing an example of the appearance of the rear cover 18c as viewed from the front left side.

In FIGS. 3A, 3B, 4A, 4B, 5A, and 5B, the drive unit 80 includes a first wall surface 18bw that is part of a wall surface of the first electrical chamber Ref, and a first opening 18bwo provided in the first wall surface 18bw. The drive unit 80 includes a second wall surface 18cw that is a part of a wall surface of the second electrical chamber Res, and a second opening 18cwo provided in the second wall surface 18cw. The second wall surface 18cw is brought into contact with the first wall surface 18bw. The second opening 18cwo is provided in the second wall surface 18cw at a position facing the first opening 18bwo. The second opening 18cwo is connected to the first opening 18bwo. The first wall surface 18bw is a wall surface that is a part of the case body 18b. The second wall surface 18cw is a wall surface that is a part of the rear cover 18c. The second wall surface 18cw is a part of the wall surface of the drive chamber Rta.

The first electrical chamber Ref and the second electrical chamber Res are connected to each other through the first opening 18bwo and the second opening 18cwo. One air chamber is formed by the first electrical chamber Ref and the second electrical chamber Res. The drive unit 80 includes a PCU busbar 84 that is passed through the first opening 18bwo and the second opening 18cwo and is disposed in the first electrical chamber Ref and the second electrical chamber Res. The PCU busbar 84 is an electrical equipment power line that electrically connects the first electrical equipment 60f and the second electrical equipment 60s. In the PCU busbar 84, a second PCU busbar 84s extending from the second electrical equipment 60s is electrically connected to a terminal portion of the first PCU busbar 84f connected to the first electrical equipment 60f by a bolt (see a portion A in FIG. 3B) etc.

The thick dashed line Lbsf in FIG. 4A and the thick dashed line Lesf in FIG. 4B indicate a seal line for sealing the drive chamber Rta (oil chamber). A thick long dashed double-short dashed line Lbsa in FIG. 4A and a thick long dashed double-short dashed line Lcsa in FIG. 4B indicate a seal line for sealing one air chamber formed by the first electrical chamber Ref and the second electrical chamber Res. Both the seal lines of the thick dashed lines Lbsf, Lesf and the seal lines of the thick long dashed double-short dashed lines Lbsa, Lcsa correspond to the mating surface between the case body 18b and the rear cover 18c.

The seal line for the oil chamber and the seal line for the air chamber are provided on the mating surface between the case body 18b and the rear cover 18c, so that the first electrical chamber Ref and the second electrical chamber Res are connected as one air chamber. This facilitates electrical connection of the divided power control unit 60 (first electrical equipment 60f, second electrical equipment 60s).

The first electrical chamber Ref is located vertically above and adjacent to the drive chamber Rta in the state in which the drive unit 80 is mounted on the vehicle 10. The second electrical chamber Res is located horizontally adjacent to each of the drive chamber Rta and the first electrical chamber Ref in the state in which the drive unit 80 is mounted on the vehicle 10.

The side cover 18d is a third wall surface that is a part of the wall surface of the second electrical chamber Res and that faces the second wall surface 18cw. The drive unit 80 includes a fourth wall surface 18cwv that is a part of the wall surface of the second electrical chamber Res. The fourth wall surface 18cwv extends perpendicularly from an end of the second wall surface 18cw toward the side cover 18d. The side cover 18d is a lid member connected to the opposite end of the fourth wall surface 18cwv from the second wall surface 18cw. The fourth wall surface 18cwv is a wall surface that is a part of the rear cover 18c. The fourth wall surface 18cwv is a part of the wall surface of the second electrical chamber Res. The second partition wall 18bp2 of the case body 18b is a fifth wall surface that separates the drive chamber Rta and the first electrical chamber Ref and that is a part of the wall surface of the drive chamber Rta and a part of the wall surface of the first electrical chamber Ref.

The drive unit 80 includes a terminal block 86. The terminal block 86 includes a relay busbar 88 and a terminal block body 90. The relay busbar 88 is such a relay power line that the electric motor (first electric motor MG1, second electric motor MG2) is electrically connected at one end of the relay power line and the first electrical equipment 60f is electrically connected at the other end of the relay power line. The terminal block body 90 is a body of the terminal block 86 to which the relay busbar 88 is integrally fixed.

The second partition wall 18bp2 of the case body 18b has a hole 92 that has a shape matching the shape of the terminal block body 90 and in which the terminal block body 90 is fitted. In the drive chamber Rta, the terminal block body 90 is fitted into the hole 92, thereby preventing leakage of the oil FLD through the hole 92.

An MG busbar 94 extending from an electric motor (first electric motor MG1, second electric motor MG2) is electrically connected to a terminal portion at one end of the relay busbar 88 by a bolt (see the portion B in FIG. 3B) etc. The relay busbar 88 is electrically connected at the other end to a terminal portion of the PCU busbar 96 connected to the first electrical equipment 60f by a bolt (see the portion A in FIG. 3B) etc.

In the drive unit 80, after the work of connecting the MG busbar 94 to the terminal portion at the one end of the relay busbar 88 and the work of connecting the other end of the relay busbar 88 to the terminal portion of the PCU busbar 96 are performed, the rear cover 18c is attached to the case body 18b. In addition, in the drive unit 80, the work of connecting the second PCU busbar 84s to the terminal portion of the first PCU busbar 84f can be performed before the side cover 18d is attached to the rear cover 18c. As a result, in the drive unit 80, no work service hole is necessary, and the service hole covers can be eliminated.

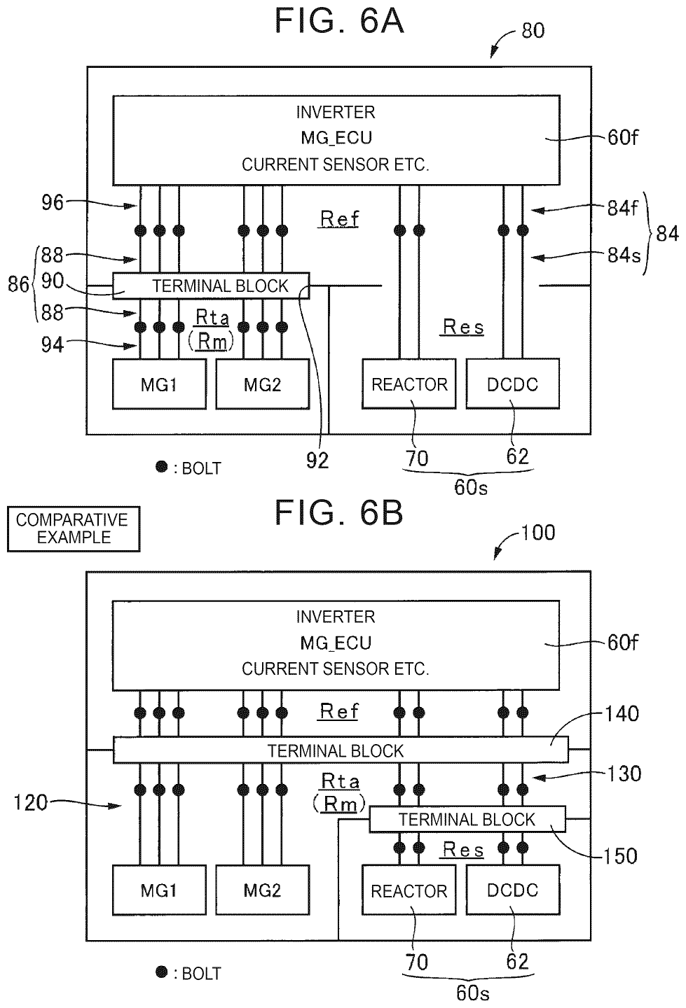

FIG. 6A is a diagram illustrating an example of electrical connection in the drive unit 80. FIG. 6A shows the electrical connection in the present embodiment. FIG. 6B shows the electrical connection in the comparative embodiment. In the vehicle drive unit 100 of the comparative example shown in FIG. 6B, the first electrical equipment 60f and the second electrical equipment 60s are electrically connected via the drive chamber Rta. In the vehicle drive unit 100, the two terminal blocks 140, 150 are provided in order to seal the drive chamber Rta so that the oil FLD does not leak. Further, in the vehicle drive unit 100, since the busbar 130 from the second electrical chamber Res is merged from the drive chamber Rta to the terminal block 140, the size of the terminal block 140 connecting the drive chamber Rta and the first electrical chamber Ref is increased. In contrast, in the drive unit 80 of the present embodiment shown in FIG. 6A, the first electrical chamber Ref and the second electrical chamber Res are one air chamber, and the PCU busbar 84 is disposed in the air chamber. Thus, in the drive unit 80, since the terminal block between the second electrical chamber Res and the drive chamber Rta is not required, it is possible to reduce the terminal block as compared with the comparative example, cost reduction is expected. Further, in the drive unit 80, as compared with the comparative example, since the number of busbars in the terminal block 86 between the drive chamber Rta and the first electrical chamber Ref is reduced, it is possible to reduce the size of the terminal block 86.

As described above, according to the present embodiment, the drive unit 80 includes the first opening 18bwo formed on the first wall surface 18bw of the first electrical chamber Ref and the second opening 18cwo formed on the second wall surface 18cw of the second electrical chamber Res. The second wall surface 18cw is in contact with the first wall surface 18bw. The second opening 18cwo is connected to the first opening 18bwo. The drive unit 80 includes a PCU busbar 84 that is passed through the first opening 18bwo and the second opening 18cwo and disposed in the first electrical chamber Ref and the second electrical chamber Res. This configuration allows the first electrical equipment 60f and the second electrical equipment 60s to be electrically connected without via the drive chamber Rta, and can therefore reduce the number of terminal blocks required for electrical connection via the drive chamber Rta. It is therefore possible to reduce an increase in the number of components when the power control unit 60 is divided and separately disposed.

According to the present embodiment, the first electrical chamber Ref is located vertically adjacent to the drive chamber Rta in the state in which the drive unit 80 is mounted on the vehicle 10. The second electrical chamber Res is located horizontally adjacently to each of the drive chamber Rta and the first electrical chamber Ref in the state in which the drive unit 80 is mounted on the vehicle 10. Accordingly, since the power control unit 60 is divided into the first electrical equipment 60f and the second electrical equipment 60s and the first electrical equipment 60f and the second electrical equipment 60s are separately mounted, the vertical size of the drive unit 80 is reduced.

According to the present embodiment, the side cover 18d is a lid member connected to the opposite end of the fourth wall surface 18cwv from the second wall surface 18cw. Accordingly, the work of electrically connecting the first electrical equipment 60f and the second electrical equipment 60s can be performed before the side cover 18d is attached to the rear cover 18c, and the service hole covers can be eliminated.

Further, according to the present embodiment, the second partition wall 18bp2 of the case body 18b, the terminal block body 90 matches the configuration of the terminal block body 90, the hole 92 into which is fitted is formed. Thus, when the terminal block body 90 is fitted into the hole 92, the oil FLD in the drive chamber Rta is prevented from leaking from the hole 92.

In addition, according to the present embodiment, the second wall surface 18cw is a part of the wall surface of the drive chamber Rta. As a result, the drive chamber Rta is ensured to function as an oil chamber.

Although the examples of the present disclosure have been described in detail with reference to the drawings, the present disclosure also applies to other modes.

For example, in the above embodiment, the integrated electromechanical unit described by exemplifying the drive unit 80 is, in a broad sense, a case in which the power control unit 60 is stored in the case in which the transaxle 82 is stored, that is, a case in which the case is arranged close to the case. For example, the integrated electromechanical unit has a configuration in which a case in which the power control unit 60 is stored and a case in which the transaxle 82 is stored are separate bodies and are fastened by bolts or the like. Alternatively, the integrated electromechanical unit may have a configuration in which a part of the power control unit 60 is also stored in a case in which the transaxle 82 is stored.

In the above embodiment, for example, the first electrical equipment 60f may include the DCDC converter 62, and the second electrical equipment 60s may include the inverter 68 etc. Either the first electrical equipment 60f or the second electrical equipment 60s is electrically connected to an electric motor (first electric motor MG1, second electric motor MG2) via a terminal block. When the power control unit 60 does not include the boost converter 66, neither the first electrical equipment 60f nor the second electrical equipment 60s includes the reactor 70.

In the above embodiment, the first electrical chamber Ref may be located vertically below the drive chamber Rta in the state in which the drive unit 80 is mounted on the vehicle 10. Alternatively, for example, the second electrical chamber Res may be located vertically from the drive chamber Rta and the first electrical chamber Ref may be located horizontally from the drive chamber Rta and the second electrical chamber Res in the state in which the drive unit 80 is mounted on the vehicle 10.

In the above embodiment, the vehicle 10 may be a parallel hybrid electric vehicle including an engine, a power transmission device that transmits power from the engine to the drive wheels, and an electric motor that transmits power to the drive wheels via the power transmission device. Alternatively, the vehicle 10 may be a series hybrid electric vehicle including an engine, a drive motor functioning as a power source, and a power supply motor. The electric motor for supplying electric power is connected to the engine so that power is transmittable, and generates electric power with the power from the engine. Alternatively, the vehicle 10 may be a so-called plug-in hybrid electric vehicle that can charge the high-voltage battery 50 with electric power supplied from an external power source. Alternatively, the vehicle 10 may be a battery electric vehicle equipped with an electric motor.

It should be noted that the embodiment described above is merely one embodiment, and the present disclosure can be implemented in a mode in which various changes and improvements are made based on the knowledge of those skilled in the art.

What is claimed is:

1. A vehicle drive unit including: an electric motor; a gear unit to which the electric motor is connected in such a manner that power is transmittable; first electrical equipment that is a part of electrical equipment; second electrical equipment that is another part of the electrical equipment; a drive chamber that houses a drive unit, the drive unit including the electric motor and the gear unit; a first electrical chamber that houses the first electrical equipment; and a second electrical chamber that houses the second electrical equipment, the drive chamber, the first electrical chamber, and the second electrical chamber being integrally arranged in such a manner that the first electrical chamber and the second electrical chamber are each adjacent to the drive chamber, the vehicle drive unit comprising:
a first wall surface that is a part of a wall surface of the first electrical chamber;
a second wall surface that is a part of a wall surface of the second electrical chamber, the second wall surface being in contact with the first wall surface;
a first opening provided in the first wall surface;
a second opening provided in the second wall surface at a position facing the first opening, the second opening being connected to the first opening; and
an electrical equipment power line that electrically connects the first electrical equipment and the second electrical equipment, the electrical equipment power line being passed through the first opening and the second opening and disposed in the first electrical chamber and the second electrical chamber.

2. The vehicle drive unit according to claim 1, wherein:
the first electrical chamber is located vertically from the drive chamber in a state in which the vehicle drive unit is mounted on a vehicle; and
the second electrical chamber is located horizontally from the drive chamber and the first electrical chamber in the state in which the vehicle drive unit is mounted on the vehicle.

3. The vehicle drive unit according to claim 2, further comprising:
a third wall surface that is a part of the wall surface of the second electrical chamber, the third wall surface facing the second wall surface; and
a fourth wall surface that is a part of the wall surface of the second electrical chamber, the fourth wall surface extending perpendicularly from an end of the second wall surface toward the third wall surface,
wherein the third wall surface is a lid member connected to an opposite end of the fourth wall surface from the second wall surface.

4. The vehicle drive unit according to claim 3, wherein:
the first electrical equipment includes a power supply unit configured to supply electric power to the electric motor;
the vehicle drive unit further includes:
a terminal block including a relay power line and a body, the electric motor being electrically connected at one end of the relay power line, the first electrical equipment being electrically connected at another end of the relay power line, and the relay power line being integrally fixed to the body; and
a fifth wall surface that is a part of a wall surface of the drive chamber and a part of the wall surface of the first electrical chamber, the fifth wall surface separating the drive chamber and the first electrical chamber;
the drive chamber has a function as an oil chamber sealed in such a manner that oil that lubricates the drive unit does not leak out; and
the fifth wall surface has a hole into which the body is fitted, the hole having a shape that matches a shape of the body.

5. The vehicle drive unit according to claim 4, wherein the second wall surface is a part of the wall surface of the drive chamber.
